(19) United States
(12) Patent Application Publication
(10) Pub. No.: US 2025/0297339 A1
(43) Pub. Date: Sep. 25, 2025

(54) A PREPARATION METHOD FOR A VANADIUM-NITROGEN ALLOY

(71) Applicant: Pangang Group Panzhihua Iron & Steel Research Institute Co., Ltd., Panzhihua (CN)

(72) Inventors: Qihua SHI, Panzhihua (CN); Yi Peng, Panzhihua (CN); Ning Wang, Panzhihua (CN); Leizhang Gao, Panzhihua (CN)

(73) Assignee: Pangang Group Panazhihua Iron & Steel Research Institute Co., Ltd., Panazhihua (CN)

(21) Appl. No.: 18/277,694

(22) PCT Filed: May 12, 2023
(86) PCT No.: PCT/CN2023/093861

§ 371 Date: Aug. 17, 2023

(30) Foreign Application Priority Data
Dec. 12, 2022 (CN) 202211588926.8

(51) Int. Cl. C22C 1/10; C22C 27/02

(52) U.S. Cl. CPC C22C 1/10; C22C 27/025

(57) ABSTRACT

The invention discloses a preparation method for a vanadium-nitrogen alloy, which comprises the following steps: a, adding ammonium vanadate into a first rotary kiln for heating and deamination to obtain a thermal vanadium oxide and a mixed gas 1; b, adding the thermal vanadium oxide into a second rotary kiln, for heating and reducing in a first protective atmosphere to obtain a vanadium oxynitride and a mixed gas 2; c, mixing a graphite powder and the vanadium oxynitride in a ratio of K:1 by mass percentage to form a mixture, and mixing and molding the mixture to obtain a dried raw meal block, wherein the vanadium oxynitride has an oxygen content of 4%-20%, and the oxygen content is divided into n intervals, and the K value is in direct proportion to the oxygen content in each interval; and d, sending the dried raw material block into a calcining kiln for carbothermal reduction and nitridation in a second protective atmosphere to obtain a vanadium-nitrogen alloy and a mixed gas 3. The method uses vanadium oxynitride to prepare vanadium-nitrogen alloy, which has the advantages of low dosage of carbonaceous reducing agent and reduced carbon emission, and realizes low-carbon and efficient preparation of the vanadium-nitrogen alloy.

### TECHNICAL FIELD

The invention relates to the field of metallurgy, and in particular to a preparation method for a vanadium-nitrogen alloy.

### BACKGROUND ART

Vanadium-nitrogen alloy is the most important and widely used vanadium alloy additive in iron and steel industry. Adding vanadium-nitrogen alloy to steel can improve its comprehensive properties. Typical vanadium-nitrogen alloy production technologies include a first generation vacuum method and a second generation atmospheric pressure one-step method. The first generation vacuum method for preparing vanadium-nitrogen alloy was industrialized by American Strategic Minerals Company in the last century. It used high temperature, vacuum, intermittent and carbon reduction methods to produce vanadium-nitrogen alloy. This process has some shortcomings, such as discontinuous process, complex equipment, large investment, long production cycle, low productivity and high energy consumption. The second generation atmospheric pressure one-step method was independently developed in China around 2000 and realized industrial production. This method realized continuous carbothermal reduction and nitridation under atmospheric pressure, but this process has some shortcomings such as high carbon content and high reaction temperature. With the country's increasingly strict requirements on carbon emission and the demand for optimization of various indexes of vanadium-nitrogen alloy, it is of great significance to develop a new generation of vanadium-nitrogen alloy preparation technology to reduce carbon emission and optimize key indexes of vanadium-nitrogen alloy production.

Therefore, there is a need to improve the preparation method of vanadium-nitrogen alloy in the prior art.

### SUMMARY OF THE INVENTION

In view of this, the purpose of the embodiment of the invention is to propose a preparation method for a vanadium-nitrogen alloy. The method of the invention uses vanadium oxynitride to prepare vanadium-nitrogen alloy, which has low dosage of carbonaceous reducing agent and reduces carbon emission. Furthermore, the method of the invention further improves the design of the kiln body, recycles the gas medium in the preparation process, and realizes the low-carbon and efficient preparation of vanadium-nitrogen alloy.

Based on the above purpose, an embodiment of the present invention provides a preparation method for a vanadium-nitrogen alloy, which comprises the following steps:
a, adding ammonium vanadate into a first rotary kiln for thermal deamination to obtain a thermal vanadium oxide and a mixed gas 1;
b, adding the thermal vanadium oxide into a second rotary kiln for thermal reduction in a first protective atmosphere to obtain a vanadium oxynitride and a mixed gas 2;
c, mixing a graphite powder and the vanadium oxynitride in a ratio of K:1 by mass percentage to form a mixture, and mixing and molding the mixture to obtain a dried raw meal block, wherein the vanadium oxynitride has an oxygen content of 4%-20%, and the oxygen content is divided into n intervals, and the K value is in direct proportion to the oxygen content in each interval; and
d, sending the dried raw material block into a calcining kiln for carbothermal reduction and nitridation in a second protective atmosphere to obtain a vanadium-nitrogen alloy and a mixed gas 3.

In some embodiments, the method of the present invention further comprises:
e, introducing all mixed gas 3 into a third rotary kiln, and simultaneously adding vanadium pentoxide into the third rotary kiln for thermal reduction to obtain a thermal vanadium oxide 2 and a mixed gas 4, circularly adding the thermal vanadium oxide 2 into the second rotary kiln, absorbing the mixed gas 4 with alkali to obtain a purified nitrogen and an absorption liquid, and circularly introducing the purified nitrogen into the calcining kiln.

In some embodiments, in step e, the mixed gas 3 includes nitrogen and carbon monoxide, the addition amount of vanadium pentoxide is 32.2-65 times of the mass of carbon monoxide in the mixed gas 3, the thermal reduction is carried out at a reaction temperature of 350-650° C. for 70-130 min.

In some embodiments, in step a, the thermal deamination is carried out at a reaction temperature of 330˜390° C. for 40˜70 min.

In some embodiments, in step b, in step b, the first protective atmosphere includes purified ammonia gas and a dried mixed gas 1, and the thermal reduction includes a first reduction reaction and a second reduction reaction, wherein:
the first reduction reaction is carried out at a heating temperature of 470° C.˜630° C. for 40˜80 min.
the second reduction reaction is carried out at a heating temperature of 740° C.˜860° C. for 50˜130 min.

In some embodiments, in step b, the vanadium oxynitride has a particle size of less than 125 μm. The vanadium oxynitride includes, by mass percentage, V 65-76%, N 10-20% and O 4-20%.

In some embodiments, in step c, the n is 4, wherein:
in a first interval, the oxygen content (O %) in the vanadium oxynitride is 4%˜8%, and K=(0.780˜0.785) O %;
in a second interval, the oxygen content (O %) in the vanadium oxynitride is 8%˜12%, and K=(0.775˜0.780) O %;
in a third interval, the oxygen content (O %) in the vanadium oxynitride is 12%˜16%, and K=(0.765˜0.775) O %; and
in a fourth interval, the oxygen content (O %) in the vanadium oxynitride is 16%˜20%, and K=(0.755˜0.765) O %.

In some embodiments, in step c, the mixing and molding includes:
adding the mixture into a wet mixer, spraying atomized water into the wet mixer until the water content in the mixture reaches 4%-9%, and continuing mixing for 15-25 min to obtain a water-containing mixture;
pressing the water-containing mixture into a raw material block in a high-pressure ball press at a pressure of 6-30 MPa; and
drying the raw material block in a drying kiln to make the water content of the raw material block less than 0.6% to obtain the dried raw material block.

In some embodiments, in step d, the second protective atmosphere includes a dried mixed gas 2 and purified nitrogen, and the flow rate of the purified nitrogen is controlled so that the amount of purified nitrogen per kilogram of the dried raw material block is 1.2˜2.4 m³, and the dried raw material block is calcined at 930-1280° C. for 50-210 min in a high-temperature constant-temperature zone in the calcining kiln and then cooled to 50-160° C. and discharged from the kiln to obtain the vanadium-nitrogen alloy.

In some embodiments, in step d, the first rotary kiln and/or the second rotary kiln and/or the third rotary kiln have a multi-section kiln body whose diameter increases first and then decreases from a first end to a second end, each section of the kiln body is provided with an independent temperature control device.

The invention has at least the following beneficial technical effects:

In this invention, vanadium oxynitride with O content less than 20% is prepared by introducing ammonia medium for reduction. According to the characteristics of vanadium oxynitride preparation process, a rotary kiln for preparing vanadium oxynitride and its use method are proposed. In this method, the diameter of both ends of the rotary kiln is small and the diameter of the middle part is large by setting the diameter and length of each section of the kiln body. After the gas medium enters the kiln body, the flow rate in the middle part is reduced due to the diameter change, and the non-residence time of materials in the kiln body is prolonged synchronously, which increases the contact time between the gas medium and vanadium oxide and promotes the reaction. Because the melting point of vanadium pentoxide is only 690° C., the melting point of materials is increased when vanadium pentoxide is transformed into vanadium nitride, vanadium trioxide and other substances with the progress of reduction and transformation. Using this as raw material to prepare vanadium-nitrogen alloy can reduce the dosage of carbonaceous reductant, thus reducing carbon emission, and the dosage of carbonaceous reductant also reduces the partial pressure of CO in the calcining kiln, thus promoting the reaction to reduce the reaction temperature and shorten the reaction time. According to the reaction characteristics in the preparation process of vanadium-nitrogen alloy, a recycling method of gas medium is designed to improve the gas medium utilization rate.

### BRIEF DESCRIPTION OF THE DRAWINGS

In order to explain the embodiments of the present invention or the technical scheme in the prior art more clearly, the attached drawings needed in the description of the embodiments or the prior art will be briefly introduced below. Obviously, the attached drawings in the following description are only some embodiments of the present invention, and other embodiments can be obtained according to the drawings without creative labor for ordinary people in the field.

FIG. 1 is a schematic diagram of an embodiment of a preparation method of vanadium oxynitride provided by the present invention; and

FIG. 2 is a schematic diagram of an embodiment of a rotary kiln provided by the present invention.

### DETAILED DESCRIPTION

In order to make the purpose, technical scheme and advantages of the present invention more clear, the embodiments of the present invention will be further described in detail with reference to specific embodiments and the attached drawings.

The terms “including” and “having” and any variations thereof in the description and claims of the present invention and the description of the above drawings, are intended to cover non-exclusive inclusion. The terms “first” and “second” in the description and claims of the present invention or the above drawings are used to distinguish different objects, not to describe a specific order. The terms “multiple” refers to two or more, unless otherwise specifically defined.

Furthermore, reference to “an embodiment” herein means that a particular feature, structure or characteristic described in connection with the embodiment can be included in at least one embodiment of the present invention. The appearance of this phrase in various places in the specification does not necessarily refer to the same embodiment, nor is it an independent or alternative embodiment mutually exclusive with other embodiments. It is understood explicitly and implicitly by those skilled in the art that the embodiments described herein can be combined with other embodiments.

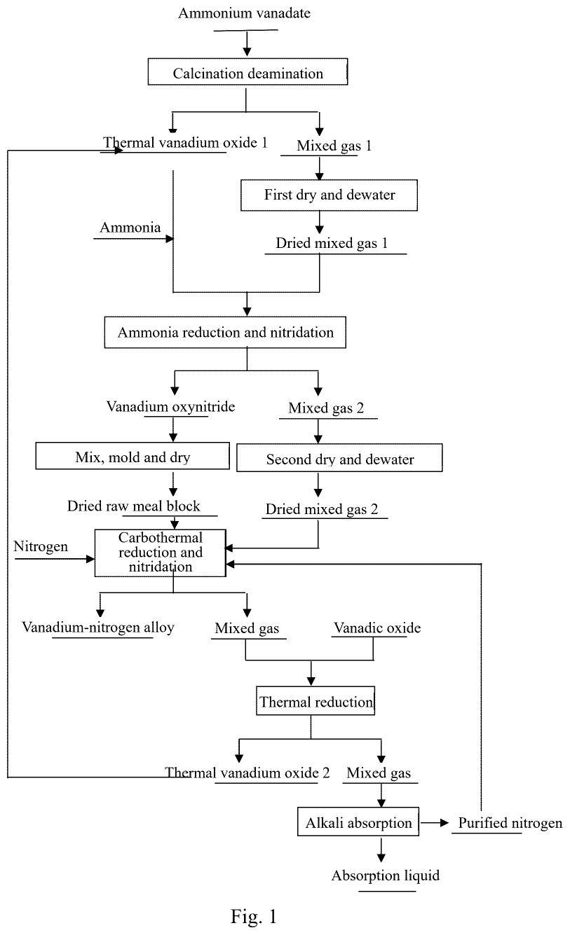

As shown in FIG. 1, the preparation method of vanadium oxynitride provided by the invention comprises the following steps:
a, adding ammonium vanadate into a first rotary kiln for thermal deamination to obtain a thermal vanadium oxide and a mixed gas 1;
b, adding the thermal vanadium oxide into a second rotary kiln for thermal reduction in a first protective atmosphere to obtain a vanadium oxynitride and a mixed gas 2;
c, mixing a graphite powder and the vanadium oxynitride in a ratio of K:1 by mass percentage to form a mixture, and mixing and molding the mixture to obtain a dried raw meal block, wherein the vanadium oxynitride has an oxygen content of 4%-20%, and the oxygen content is divided into n intervals, and the K value is in direct proportion to the oxygen content in each interval; and
d, sending the dried raw material block into a calcining kiln for carbothermal reduction and nitridation in a second protective atmosphere to obtain a vanadium-nitrogen alloy and a mixed gas 3.

In some embodiments, the method of the present invention further comprises:
e, introducing all mixed gas 3 into a third rotary kiln, and simultaneously adding vanadium pentoxide into the third rotary kiln for thermal reduction to obtain a thermal vanadium oxide 2 and a mixed gas 4, circularly adding the thermal vanadium oxide 2 into the second rotary kiln, absorbing the mixed gas 4 with alkali to obtain a purified nitrogen and an absorption liquid, and circularly introducing the purified nitrogen into the calcining kiln.

Further, in step a, the ammonium vanadate is at least one of ammonium metavanadate, ammonium hexavanadate and ammonium decavanadate. In terms of mass percentage, K₂O+Na₂O≤1.5%, P≤0.12%, S≤0.25% in the ammonium vanadate. The thermal deamination is carried out at a reaction temperature of 330˜390° C. for 40˜70 min. The thermal vanadium oxide in the reaction product is V₂O₅, and the mixed gas 1 includes ammonia and a small amount of water vapor, nitrogen and hydrogen. In a preferred embodiment, the mixed gas 1 can be dried to remove water, and the desiccant calcium oxide is used, and the water volume fraction in the dried mixed gas 1 is less than or equal to 0.15%.

Further, in step b, the first protective atmosphere includes purified ammonia gas and the dried mixed gas 1, and the heating reduction includes a first reduction reaction and a second reduction reaction, wherein:
the first reduction reaction is carried out at a heating temperature of 470° C.˜630° C. for 40˜80 min.
the second reduction reaction is carried out at a the heating temperature of 740° C.˜860° C. for 50˜130 min.

In the first reduction reaction, a relatively low heating temperature is used, because the thermal vanadium oxide is mainly V₂O₅ with a relatively low melting point of about 650˜690° C., a lower temperature is used to prevent its melting. However, with the heating reaction, the valence of vanadium decreases and its melting point gradually increases, so the temperature is raised in the second reduction reaction to ensure the efficient reaction, and the temperature at this time still does not exceed the melting point of reactants. The finally prepared vanadium oxynitride has a particle size of less than 125 μm. The vanadium oxynitride includes, by mass percentage, V 65-76%, N 10-20% and O 4-20%.

In some embodiments, the mixed gas 2 includes unreacted ammonia, water vapor and nitrogen. Due to the high concentration of water vapor, it is not conducive to ammonia reduction and nitridation. Therefore, the mixed gas 2 can be used for ammonia reduction and nitridation after drying treatment.

Further, in step c, the graphite powder has a fixed carbon content of ≥98%, and a particle size of less than 125 μm. In some embodiments, the n is set to 4, that is, the oxygen content is divided into four intervals, wherein:
in a first interval, the oxygen content (O %) in the vanadium oxynitride is 4%˜8%, and K=(0.780˜0.785) O %;
in a second interval, the oxygen content (O %) in the vanadium oxynitride is 8%˜12%, and K=(0.775˜0.780) O %;
in a third interval, the oxygen content (O %) in the vanadium oxynitride is 12%˜16%, and K=(0.765˜0.775) O %; and
in a fourth interval, the oxygen content (O %) in the vanadium oxynitride is 16%˜20%, and K=(0.755˜0.765) O %.

Further, in step c, the mixing and molding includes:
adding the mixture into a wet mixer, spraying atomized water into the wet mixer until the water content in the mixture reaches 4%-9%, and continuing mixing for 15-25 min to obtain a water-containing mixture;
pressing the water-containing mixture into a raw material block in a high-pressure ball press at a pressure of 6-30 MPa; and
drying the raw material block in a drying kiln to make the water content of the raw material block less than 0.6% to obtain the dried raw material block.

Further, in step d, the second protective atmosphere includes the dried mixed gas 2 and purified nitrogen, and the flow rate of the purified nitrogen is controlled so that the amount of purified nitrogen per kilogram of dried raw material block is 1.2˜2.4 m³, and the dried raw material block is calcined at 930-1280° C. for 50-210 min in a high-temperature constant-temperature zone in the calcining kiln and then cooled to 50-160° C. and discharged from the kiln to obtain the vanadium-nitrogen alloy.

Further, in step e, the mixed gas 3 includes nitrogen and carbon monoxide, the addition amount of vanadium pentoxide is 32.2-65 times of the mass of carbon monoxide in the mixed gas 3, the thermal reduction carried out at a reaction temperature of 350-650° C. for 70-130 min. In some preferred embodiments, sodium hydroxide is used for the alkali absorption.

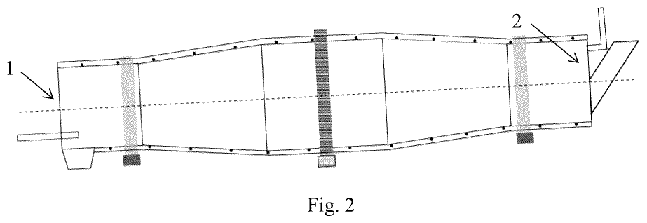

FIG. 2 is a schematic diagram of an embodiment of the rotary kiln provided by the present invention. In some embodiments of the present invention, the first rotary kiln and/or the second rotary kiln and/or the third rotary kiln have a multi-section kiln body. The multi-section kiln body has a first end 1 and a second end 2, and is symmetrically distributed in an axial direction. The kiln body has a diameter first increases and then decreases from the first end 1 to the second end 2, that is, the kiln body has a shape with a wide middle and narrow ends. Each section of the kiln body is provided with heating coils, which are controlled by corresponding power sources to achieve independent temperature control in each zones. In the invention, the diameter and length of each section of the rotary kiln body are set to make the diameter of both ends of the rotary kiln small and the diameter of the middle part large, so that after the gas medium enters the kiln body, the flow rate at the middle part is reduced due to the diameter change, and the non-residence time of materials in the kiln body is also synchronously prolonged, so that the contact time between the gas medium and vanadium oxide is increased, and the reaction is promoted. In addition, the method uses heating coils to control the temperature distribution in each area of the rotary kiln, this allows the materials to enter the high temperature area after pre-reduction in the low temperature area, avoiding the melting and agglomeration of vanadium oxides.

According to the invention, the vanadium-nitrogen alloy prepared by using vanadium oxynitride as a raw material can reduce the dosage of the carbonaceous reducing agent, thereby reducing the carbon emission; the dosage of the carbonaceous reducing agent also reduces the partial pressure of CO in the calcining kiln, thus promoting the reaction, further reducing the reaction temperature and shortening the reaction time; and according to the reaction characteristics in the preparation process of the vanadium-nitrogen alloy, a recycling method of the gas medium is designed, thereby improving the utilization rate of the gas medium.

Specific embodiments of the present invention will be further described below according to specific embodiments.

### Embodiment 1

Add ammonium vanadate into a first rotary kiln, heat to 345° C. in an atmosphere isolated from air for reaction for 67 min for deamination to obtain a thermal vanadium oxide and a mixed gas. Make the thermal vanadium oxide directly enter a second rotary kiln, heat to 510° C. for reaction for 51 min in a protective atmosphere, and then allow it to react at 825° C. for 98 min to obtain a thermal vanadium oxynitride. Mke the thermal vanadium oxynitride enter an outer wall water-cooled cooling cylinder, and cool to 40° C. in a protective atmosphere to obtain vanadium oxynitride with V 70.3%, N 14.8%, O 14.1%. Mix graphite powder and the vanadium oxynitride evenly according to the mass ratio of 0.108:1 to obtain a mixture. Add the mixture into a wet mixer, start the wet mixer, spray atomized water into the wet mixer until the water content in the mixture reaches 18%, then stop spraying atomized water, continue mixing for 18 min, and then turn off the wet mixer to obtain a water-containing mixture. Press the water-containing mixture into a block by a high-pressure ball press under the pressure of 15 MPa to obtain a raw material block. Make the raw material block enter a drying kiln, and dry at the temperature of 160° C. until the water content is 0.4%, to obtain a dried raw material block. Make the dried raw material block enter a calcining kiln, calcine for 120 min in a high-temperature constant temperature area of 1070° C. in nitrogen atmosphere, and then cool to 83° C. and then discharge from the kiln to obtain a vanadium-nitrogen alloy.

### Embodiment 2

Add ammonium vanadate into a first rotary kiln, heat to 375° C. in an atmosphere isolated from air for reaction for 48 min for deamination to obtain a thermal vanadium oxide and a mixed gas. Make the thermal vanadium oxide directly enter a second rotary kiln, heat to 625° C. for reaction for 47 min in a protective atmosphere, and then allow it to react at 798° C. for 95 min to obtain a thermal vanadium oxynitride. Make the hot vanadium oxynitride enter an outer wall water-cooled cooling cylinder, and cool to 40° C. in a protective atmosphere to obtain vanadium oxynitride with V 74.8%, N 16.3%, O 8.2%. Mix graphite powder and the vanadium oxynitride evenly according to the mass ratio of 0.0636:1 to obtain a mixture. Add the mixture into a wet mixer, start the wet mixer, spray atomized water into the wet mixer until the water content in the mixture reaches 8%, then stop spraying atomized water, continu mixing for 22 min, and then turn off the wet mixer to obtain a water-containing mixture. Press the water-containing mixture into a block by a high-pressure ball press under the pressure of 23 MPa to obtain a raw material block. Make the raw material block enter a drying kiln and dry at the temperature of 210° C. until the water content is 0.5%, to obtain a dried raw material block. Make the dried raw material block enter a calcining kiln, calcine for 95 min in a high-temperature constant temperature area of 980° C. in nitrogen atmosphere, and then cool to 57° C. and then discharge from the kiln to obtain a vanadium-nitrogen alloy.

### Embodiment 3

Add ammonium vanadate into a first rotary kiln, heat to 388° C. in an atmosphere isolated from air for reaction for 53 min for deamination to obtain a thermal vanadium oxide and a mixed gas. Make the thermal vanadium oxide directly enter a second rotary kiln, heat to 609° C. for reaction for 77 min in a protective atmosphere, and then allow it to react at 844° C. for 113 min to obtain a thermal vanadium oxynitride. Make the hot vanadium oxynitride enter an outer wall water-cooled cooling cylinder, and cool to 36° C. in a protective atmosphere to obtain vanadium oxynitride with V 68.7%, N 12.6%, O 17.9%. Mix graphite powder and the vanadium oxynitride evenly according to the mass ratio of 0.136:1 to obtain a mixture. Add the mixture into a wet mixer, start the wet mixer, spray atomized water into the wet mixer until the water content in the mixture reaches 5%, then stop spraying atomized water, continu mixing for 23 min, and then turn off the wet mixer to obtain a water-containing mixture. Press the water-containing mixture into a block by a high-pressure ball press under the pressure of 10 MPa to obtain a raw material block. Make the raw material block enter a drying kiln and dry at the temperature of 140° C. until the water content is 0.4%, to obtain a dried raw material block. Make the dried raw material block enter a calcining kiln, calcine for 150 min in a high-temperature constant temperature area of 1230° C. in nitrogen atmosphere, and then cool to 130° C. and then discharge from the kiln to obtain a vanadium-nitrogen alloy.

The above is an exemplary embodiment of the present invention, but it should be noted that various changes and modifications can be made without departing from the scope of the embodiment of the present invention as defined by the claims. The functions, steps and/or actions of the method claims according to the disclosed embodiments described herein need not be performed in any particular order. In addition, although the elements disclosed in the embodiments of the present invention can be described or claimed in individual form, they can also be understood as plural unless explicitly limited to the singular.

It should be understood that as used herein, the singular form “a” and “an” are intended to include the plural form, unless the context clearly supports exceptions. It should also be understood that “and/or” as used herein is meant to include any and all possible combinations of one or more associated listed items.

The embodiment serial number disclosed in that embodiment of the invention are only for description, and do not represent the advantages and disadvantages of the embodiments.

It should be understood by those skilled in the art that the discussion of any of the above embodiments is only exemplary, and it is not intended to imply that the disclosed scope (including claims) of the embodiments of the present invention is limited to these examples; Under the idea of the embodiment of the present invention, the technical features in the above embodiments or different embodiments can also be combined, and there are many other variations in different aspects of the embodiment of the present invention as described above, which are not provided in the details for the sake of conciseness. Therefore, any omission, modification, equivalent substitution, improvement, etc. made within the spirit and principle of the embodiment of the present invention should be included in the protection scope of the embodiment of the present invention.

1. A preparation method for a vanadium-nitrogen alloy, characterized by comprising:
a, adding ammonium vanadate into a first rotary kiln for thermal deamination to obtain a thermal vanadium oxide and a mixed gas 1;
b, adding the thermal vanadium oxide into a second rotary kiln for thermal reduction in a first protective atmosphere to obtain a vanadium oxynitride and a mixed gas 2;
c, mixing a graphite powder and the vanadium oxynitride in a ratio of K:1 by mass percentage to form a mixture, and mixing and molding the mixture to obtain a dried raw meal block, wherein the vanadium oxynitride has an oxygen content of 4%-20%, and the oxygen content is divided into n intervals, and the K value is in direct proportion to the oxygen content in each interval; and
d, sending the dried raw material block into a calcining kiln for carbothermal reduction and nitridation in a second protective atmosphere to obtain a vanadium-nitrogen alloy and a mixed gas 3.

2. The preparation method for a vanadium-nitrogen alloy according to claim 1, characterized by further comprising:
e, introducing all mixed gas 3 into a third rotary kiln, and simultaneously adding vanadium pentoxide into the third rotary kiln for thermal reduction to obtain a thermal vanadium oxide 2 and a mixed gas 4, circularly adding the thermal vanadium oxide 2 into the second rotary kiln, absorbing the mixed gas 4 with alkali to obtain a purified nitrogen and an absorption liquid, and circularly introducing the purified nitrogen into the calcining kiln.

3. The preparation method for a vanadium-nitrogen alloy according to claim 2, characterized in that in step e, the mixed gas 3 includes nitrogen and carbon monoxide, the addition amount of vanadium pentoxide is 32.2-65 times of the mass of carbon monoxide in the mixed gas 3, the thermal reduction is carried out at a reaction temperature of 350-650° C. for 70-130 min.

4. The preparation method for a vanadium-nitrogen alloy according to claim 2, characterized in that in step a, the thermal deamination is carried out at a reaction temperature of 330˜390° C. for 40˜70 min.

5. The preparation method for a vanadium-nitrogen alloy according to claim 2, characterized in that in step b, in step b, the first protective atmosphere includes purified ammonia gas and a dried mixed gas 1, and the thermal reduction includes a first reduction reaction and a second reduction reaction, wherein:
the first reduction reaction is carried out at a heating temperature of 470° C.˜630° C. for 40˜80 min.
the second reduction reaction is carried out at a heating temperature of 740° C.˜860° C. for 50˜130 min.

6. The preparation method for a vanadium-nitrogen alloy according to claim 2, characterized in that in step b, the vanadium oxynitride has a particle size of less than 125 μm, and the vanadium oxynitride includes, by mass percentage, V 65-76%, N 10-20% and O 4-20%.

7. The preparation method for a vanadium-nitrogen alloy according to claim 2, characterized in that in step c, the n is 4, wherein:
in a first interval, the oxygen content (O %) in the vanadium oxynitride is 4%˜8%, and K=(0.780˜0.785) O %;
in a second interval, the oxygen content (O %) in the vanadium oxynitride is 8%˜12%, and K=(0.775˜0.780) O %;
in a third interval, the oxygen content (O %) in the vanadium oxynitride is 12%˜16%, and K=(0.765˜0.775) O %; and
in a fourth interval, the oxygen content (O %) in the vanadium oxynitride is 16%˜20%, and K=(0.755˜0.765) O %.

8. The preparation method for a vanadium-nitrogen alloy according to claim 2, characterized in that in step c, the mixing and molding includes:
adding the mixture into a wet mixer, spraying atomized water into the wet mixer until the water content in the mixture reaches 4%-9%, and continuing mixing for 15-25 min to obtain a water-containing mixture;
pressing the water-containing mixture into a raw material block in a high-pressure ball press at a pressure of 6-30 MPa; and
drying the raw material block in a drying kiln to make the water content of the raw material block less than 0.6% to obtain the dried raw material block.

9. The preparation method for a vanadium-nitrogen alloy according to claim 2, characterized in that in step d, the second protective atmosphere includes a dried mixed gas 2 and purified nitrogen, and the flow rate of the purified nitrogen is controlled so that the amount of purified nitrogen per kilogram of the dried raw material block is 1.2˜2.4 m³, and the dried raw material block is calcined at 930-1280° C. for 50-210 min in a high-temperature constant-temperature zone in the calcining kiln and then cooled to 50-160° C. and discharged from the kiln to obtain the vanadium-nitrogen alloy.

10. The preparation method for a vanadium-nitrogen alloy according to claim 9, characterized in that, the first rotary kiln and/or the second rotary kiln and/or the third rotary kiln have a multi-section kiln body whose diameter increases first and then decreases from a first end to a second end, each section of the kiln body is provided with an independent temperature control device.
